(19) United States
(12) Patent Application Publication
(10) Pub. No.: US 2003/0056108 A1
(43) Pub. Date: Mar. 20, 2003

(54) Long-term storage and renewal of encrypted data

(76) Inventors: Marco Casassa Mont, Bristol (GB); Keith Alexander Harrison, Monmouthshire (GB)

Correspondence Address: HEWLETT-PACKARD COMPANY, Intellectual Property Administration, P. O. Box 272400, Fort Collins, CO, 80527-2400, US

(21) Appl. No.: 10/245,732

(22) Filed: Sep. 17, 2002

(30) Foreign Application Priority Data
Sep. 18, 2001 (GB) 0122455.9

(51) Int. Cl. H04L 9/32

(52) U.S. Cl. 713/193

(57) ABSTRACT

A method and apparatus that allows renewal of encoded data in a long-term storage. Original user data 200 is encrypted to form encrypted data 211 which can be accessed using one or more encryption secrets 213 stored separately, and optionally validated using context data 212. At renewal, the encrypted data 211, the context data 212, and the or each encryption secret 213 are combined to form a first encryption layer 210 and the first encryption layer 210 is itself encrypted to form the encrypted data 221 of an immediately succeeding second encryption layer 220. The encrypted data 221 of this second encryption layer 220 is accessible with a renewed encryption secret 223, and optionally is validated by context data 222 such as a time stamp and trusted signature. The method may be repeated recursively, forming third and subsequent encryption layers 230 at each renewal.

### FIELD OF THE INVENTION

The present invention relates in general to long-term storage of encrypted data, and in a particular to a method and apparatus for renewal of encrypted data in a long-term storage facility.

### DESCRIPTION OF THE RELATED ART

It is desired to store data in a machine-readable form, on a recording medium. The owner of the data may undertake such storage, or may pass the data to a storage service provider. In either case, it is desired to encrypt the data, such that the encrypted data is only accessible to an authorised party in possession of an encryption secret. Where the data is to be stored for an extended period of time, such as many years, possibly of the order of 30, 50 or 100 years, then the context of the stored data is likely to change. For example, an encryption mechanism used to encrypt the encrypted data might become out-dated, such as by becoming vulnerable to subversion. Alternatively, an encryption secret used to encrypt the encrypted data may have been compromised, such as by being disclosed to an unauthorised party. More powerful encryption mechanisms may become available, which were not available when the encrypted data was originally encrypted. Further, storage of the encrypted data may be time-limited, for example because a signature available to establish validity of the encrypted data has a set expiry date. Hence, a need has been identified for the renewal of encrypted data.

### SUMMARY OF THE INVENTION

An aim of the present invention is to provide a method and apparatus for use in the long-term storage of encrypted data, which allows the encrypted data to be renewed or refreshed from time to time. A preferred aim is to provide a method and apparatus for renewal of encrypted data.

According to a first aspect of the present invention there is provided a method for renewal of encrypted data, comprising the steps of: receiving an encrypted data; receiving an encryption secret required to access the encrypted data; attaching the encryption secret to the encrypted data to form an inner encryption layer; and encrypting the inner encryption layer to form a renewed outer encrypted data associated with a renewed outer encryption secret.

This method is particularly intended for use with encrypted data in a long-term storage facility. As a preliminary step, original data is received from an owner and is encrypted to form the encrypted data. The encrypted data is only accessible by the owner or other party who has possession of the encryption secret. Hence, the owner has a high degree of trust in the privacy of the encrypted data. Preferably, the encrypted data is formed with a content-encryption algorithm, such as by using a symmetric secret-key algorithm, suitably a password-based encryption algorithm. Here, the encrypted data is sealed, such that only an authorised party holding the encryption secret can open the encrypted data. Any suitable encryption can be employed, associated with one, or more, encryption secrets.

Preferably, the encrypted data is associated with context information. The context information includes, for example, information about the nature of the encryption algorithm used to form the encrypted data. Further, the context information preferably includes validity information which allows the validity of the encrypted data to be established with a high degree of trust. For example, the validity information is a digital signature associated with the encrypted data, or a time-stamp associated with the encrypted data. The encrypted data and the optional context information are preferably stored together in the long-term storage facility, whilst the encryption secret is held separately.

In the preferred method, when it is desired to renew the encrypted data, then the or each encryption secret is attached to the encrypted data and the optional context information, to form the encryption layer. The encryption layer is then encrypted to form a renewed encryption data associated with a renewed encryption secret. The renewed encryption data is preferably associated with renewed context information. For example, the renewed context information provides information about the encryption algorithm used to form the renewed encrypted data, and optionally includes information allowing validity of the renewed encrypted data to be established such as a digital signature or a time stamp.

Preferably, the original encryption secret is destroyed or discarded at all instances outside the renewed encrypted data. This is because the or each original encryption secret now forms part of the inner encryption layer, and so is available within the renewed encrypted data to any authorised party holding the renewed encryption secret. Hence, only the renewed encryption secret is required in order to access the outer encryption layer. The inner encryption layer itself contains everything required to decrypt the encrypted data within that layer.

The method is preferably repeated recursively, with the previously renewed encrypted data and the previously renewed encryption secret forming the encrypted data and the encryption secret mentioned above, such that a plurality of layers are formed.

According to a second aspect of the present invention there is provided a method for long-term storage of data, comprising the steps of: encrypting an original user data using one or more encryption secrets, to form an encrypted data of a first, innermost encryption layer; attaching the one or more encryption secrets to the encrypted data of the innermost layer, and encrypting the encrypted data and the one or more encryption secrets of the innermost layer to form an encrypted data of a second layer, using one or more encryption secrets of the second layer; and forming third and subsequent layers by encrypting an encryption data and one or more encryption secrets of each immediately preceding layer.

Preferably, each encryption layer comprises validity information for validating the encoded data in that layer. Preferably, the method includes providing context information including a time stamp when forming each encryption layer. Preferably, the method includes forming context information including a digital signature in each encryption layer.

As each layer is formed, the method preferably comprises passing the one or more encryption secrets of that layer to an authorised holder. Here, the method preferably comprises receiving the one or more encryption secrets of a current outermost layer from the authorised holder, forming a new outermost layer that includes the one or more encryption secrets of the current outermost layer, and returning the one or more encryption secrets of the new outermost layer to the authorised holder.

Further according to the present invention there is provided a method of retrieving data from a long-term storage, comprising the steps of: retrieving an encoded data comprising a plurality of encryption layers including an outermost layer and one or more inner layers, each inner layer comprising an encrypted data and one or more encryption secrets; receiving one or more outermost encryption secrets from an authorised holder; decrypting the outermost layer of the plurality of encryption layers, using the one or more outermost encryption secrets, such that the encrypted data and one or more encryption secrets of an immediately preceding layer of the plurality of layers is revealed; repeating said decrypting step, until an innermost layer is obtained; and decrypting the encrypted data of the innermost layer to reveal an original data.

Preferably, the or each layer comprises context information, and the method comprises the step of validating the encrypted data of each layer using the context information. Preferably, the context information includes a time stamp and a digital signature.

Also according to the present invention there is provided an apparatus for renewal of encrypted data, comprising: a storage unit adapted to store encrypted data; a renewal module adapted to receive the encrypted data from the storage unit, and to receive an encryption secret required to open the encrypted data, to attach the encryption secret to the encrypted data to form an encryption layer, and to encrypt the encryption layer to form a renewed encrypted data and a renewed encryption secret.

Preferably, the renewal module is arranged to store the renewed encrypted data in the storage unit, preferably replacing the original encrypted data. Preferably, the renewal module is arranged to form context information attached to the encrypted data to form the encryption layer, and/or is arranged to form context information associated with the renewed encrypted data. Here, the apparatus preferably comprises a time stamper arranged to provide a time stamp associated with the renewed encrypted data, suitably giving the time of encryption of the renewed encrypted data. Also, the apparatus preferably comprises a trusted signer arranged to provide a digital signature to the renewed encrypted data.

Preferably, the renewal module is arranged to receive the original encryption secret from an authorised holder, and is arranged to pass the renewed encryption secret to the authorised holder to supersede the original encryption secret.

According to a further aspect of the present invention there is provided an apparatus for long-term storage of encrypted data, comprising: a storage unit for storing a current encrypted data; a renewal module for attaching the current encrypted data to one or more encryption secrets required to access the current encrypted data, to form an encryption layer; and an encryption unit for encrypting the encryption layer to form a renewed encryption data, using one or more renewed encryption secrets.

Preferably, the encryption unit is arranged to store the renewed encrypted data in the storage unit, to replace the current encrypted data.

Preferably, the renewal module is arranged to receive one or more current encryption secrets from an authorised holder when forming the encryption layer, and is arranged to pass the one or more renewed encryption secrets to the authorised holder.

The apparatus may comprise a context unit arranged to form context information associated with the renewed encrypted data. Preferably, the context unit forms validity information for validating the renewed encrypted data. Preferably, the context unit comprises a digital signer and a time stamper.

Preferably, the apparatus is adapted to decrypt the current encrypted data using the one or more renewed encryption secrets, thereby revealing the encrypted data and the one or more encryption secrets of an immediately preceding layer, and to repeatedly decrypt the encrypted data of each layer using the one or more encryption secrets of that layer until an original data is revealed.

Preferably, the apparatus is arranged to validate the encrypted data of each layer using context information for that layer.

According to a further aspect of the present invention there is provided a system for long-term storage of data, comprising: a user apparatus for supplying an original user data and for holding one or more encryption secrets; a storage unit for storing the original user data as an encrypted data; and a storage controller for renewing the encrypted data, the storage controller comprising: a renewal unit for attaching the encrypted data from the storage unit to the one or more encryption secrets from the user apparatus to form an inner encryption layer; and an encryption unit for encrypting the inner encryption layer to form a renewed encryption data for storing by the storage unit, and one or more renewed encryption secrets for holding by the user apparatus.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic diagram showing a preferred apparatus for storage and renewal of encrypted data;

FIG. 2 illustrates evolution of encrypted data during renewal; and

FIG. 3 shows a preferred method for renewal of encrypted data.

### DESCRIPTION OF THE PREFERRED EMBODIMENT

The preferred embodiments of the present invention will be described using the example of an owner of valuable data who wishes to use a storage service provider to store this valuable data for an extended period of time, such as a number of years. The data owner desires privacy, in that the stored data should only be accessible to an authorised party. Also, the owner desires that the storage service provider is able to renew the stored data, such as when improved encryption mechanisms become available or if the owner feels that access to the stored data may be vulnerable to subversion or might be compromised. The storage service provider desires to store the owner's valuable data for the agreed period, and to demonstrate that retrieved data corresponds to the owner's original data and that planned renewal tasks have been fulfilled as agreed. These desires are particularly important where the data is to be stored over, say, 30, 50 or 100 years.

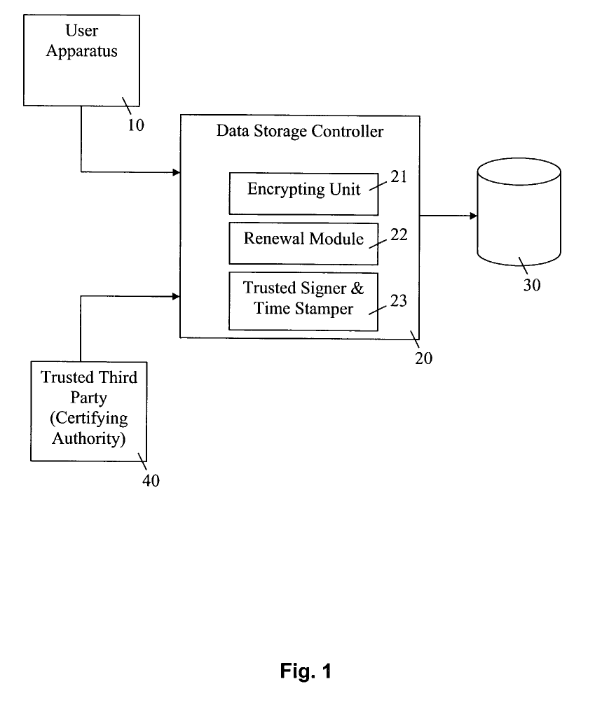

FIG. 1 shows a preferred system for the long-term storage of data. A user apparatus 10 is coupled to a storage controller 20 and a storage unit 30. Optionally, the system includes one or more trusted third party apparatus 40. Suitably, the user apparatus 10 is under the control of the owner of original data, whilst the storage controller 20 and the storage unit 30 are under the control of a storage service provider.

In this example system, the user apparatus 10 is conveniently a computing platform, and can take any suitable form. For example, the user apparatus is a relatively portable handheld device such as a cellular telephone, personal digital assistant, a laptop computer or a palmtop computer. In another example the user apparatus 10 is a relatively non-portable device such as a desktop computer.

The storage controller 20 is conveniently a computing platform such as a relatively powerful server, which operates in close co-operation with the storage unit 30. The storage controller 20 comprises, amongst other elements, and encrypting unit 21, a renewal module 22, and a trusted signer and time stamper 23. The data storage unit 30 can take any suitable form, for example comprising a bank of magnetic tape storage units, magnetic disk storage units, optical disk storage units, random access memories or any other suitable storage medium.

In use, data originating from the owner 10 is encrypted for privacy. As one example, digital enveloping is performed to seal the original data in such a way that no one other than an authorised party can open the sealed encrypted data. The original data is suitably encrypted with a secret-key algorithm such that the encrypted data is statistically impossible to open except with the secret-key. The secret key then forms an encryption secret. As a more complex example, the original data is suitably encrypted using an asymmetric encryption algorithm such as RSA, using a private key or public key of a private key and public key pair. Where the private key is used for encryption, then the public key forms an encryption secret, or vice versa. These are just two examples and many other encryption techniques are available.

The encrypted data is stored in the storage 30, and the encryption secret is held by an authorised party, which in this case is the owner 10. Hence, only the owner, as holder of the encryption secret, has access to the encrypted data. This initial encryption can be performed at the user apparatus 10, or preferably at the encryption unit 21 of the storage controller 20.

The original encrypted data is suitably associated with context information, such as a signature obtained from a trusted third party 40 and/or a signature obtained from the trusted signer 23 within the storage controller 20. The context information also suitably includes a time stamp obtained from the time stamper 23.

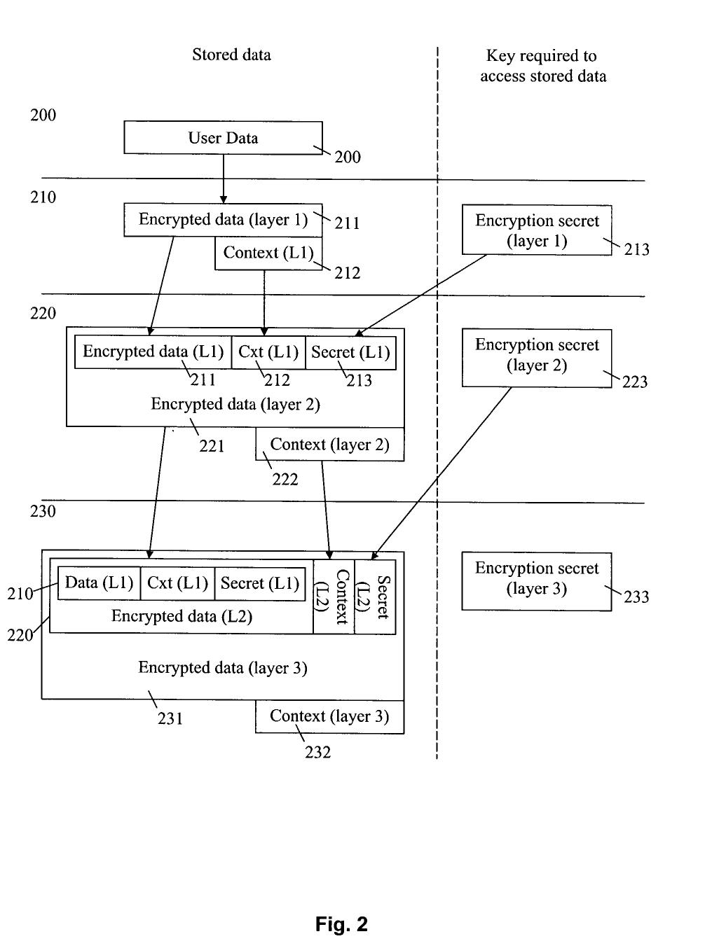

FIG. 2 illustrates evolution of the stored data.

The original user data 200 is suitably received in a clear readable form, for example as plain ASCII text. A first encryption layer 210 is formed by encrypting the user data 200 to produce encrypted data 211, which is suitably signed and time stamped to produce context data 212. The encrypted data 211 and the context data 212 are stored together in the storage unit 30. The encrypted data 211 is accessible by using an encryption secret 213 which is ideally stored securely separately. This first layer 210 suitably represents an innermost layer of the stored data.

When it is desired to renew the innermost layer, then the currently stored encrypted data 211 and context data 212 are augmented by attaching the encryption secret 213, and the whole inner layer 210 is encrypted to form renewed encrypted data 221 of a second layer 220. The encrypted data 221 is preferably associated with context data 222, such as a digital signature and time stamp. The encryption secret 213 of the first layer can now be discarded at all instances outside the encrypted data 221. The encrypted data 221 is accessible with a new encryption secret 223, which is held securely separately.

FIG. 2 also shows a third layer 230 which contains the whole of the second layer 220, which in turn contains the whole of the first layer 210.

Many further evolutions of the stored data are formed as required during the storage term, with each successive layer being applied to contain encoded data including the whole of the immediately preceding layer. In the preferred method, the stored data evolves monotonically.

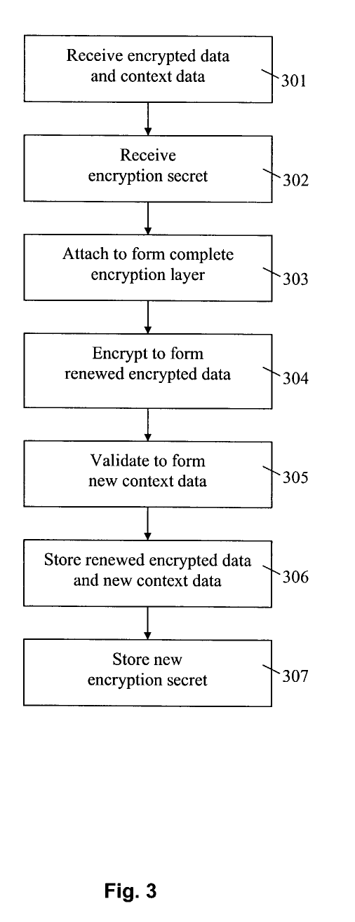

FIG. 3 illustrates a preferred method for renewal of the stored data. The method can be applied to the data storage system shown in FIG. 1, and allows the stored data to evolve as shown in FIG. 2.

In step 301, encrypted data 211 is received from the storage unit 30, by the renewal module 22 of the storage controller 20. The optional context data 212 is likewise received. Optionally, the context data is used to verify the encrypted data 211, to confirm that the encrypted data 211 received from the storage unit 30 is still valid. For example, a digital signature forming part of the context data 212 is checked such as by using a signature checking key made publicly available by the trusted certifying authority 40.

Step 302 comprises receiving the encryption secret 213 from its secure location, which in this example is the user apparatus 10 of the data owner. Hence, in this example, the renewal operation requires the co-operation of the data owner. In another embodiment, the encryption secret is stored by a trusted third party 40 or by the storage provider 20, and so is available in the renewal process with the consent of the data owner 10.

Step 303 comprises attaching the encryption secret 23 to the encrypted data 211 and the context data 212 to form the complete encryption layer 210.

Step 304 comprises encrypting this complete encryption layer 210 to form the renewed encrypted data 221 of the new, second layer. Here, the encrypted data 221 of the new layer contains all of the encryption secrets required to access encrypted data in the immediately preceding layer, in this case the first layer 210. This encryption is suitably performed by the encrypting unit 21 according to available cryptographic techniques.

In step 305 the renewed encrypted data 221 of the new second layer is validated to form new context data 222.

Step 306 comprises storing the renewed encrypted data 221, together with the optional context data 222, in the storage unit 30.

In step 307, the new encryption secret or secrets 223 required to access the renewed encrypted data 221 are stored in a secure location, to be available at the next renewal or if the owner now requires access to the stored data.

The method and apparatus described above have many advantages. Long-term storage of encoded data is made more convenient, by allowing for renewal of the encoded data from time to time during the storage period. For example, renewal is performed at regular intervals specified in a contract between the data owner and the storage service provider. Further, the storage provider is able to show an accurate and reliable historical track of the renewal operations performed on the stored encoded data, and can demonstrate that the stored data derived from the original data supplied by the owner. The system is simple and convenient to operate and to administer. Many encryption layers are formed, and each encryption layer is accessible by decrypting the encryption data of the immediately succeeding layer. Hence, only the encryption secret or secrets of the outermost layer are required in order to sequentially access each of the one or more inner layers. Further, as each layer is decrypted, context data becomes available and can be used to verify the encryption data of that layer. Other features and advantages will be apparent from the description herein.

1. A method for renewal of encrypted data, comprising the steps of:
receiving an encrypted data;
receiving an encryption secret required to access the encrypted data;
attaching the encryption secret to the encrypted data to form an inner encryption layer; and
encrypting the inner encryption layer to form a renewed outer encrypted data associated with a renewed outer encryption secret.

2. The method of claim 1, comprising receiving context information that allows validity of the encrypted data to be established, and attaching the context information to the encrypted data when forming the encryption layer.

3. The method of claim 1, comprising forming renewed context information that allows validity of the renewed encrypted data to be established.

4. The method of claim 1, comprising storing the renewed encrypted data in a long-term storage facility.

5. The method of claim 1, wherein the method is repeated recursively to form a plurality of encryption layers, each encryption layer containing encrypted data of an immediately preceding encryption layer, and one or more encryption secrets required to access the encrypted data.

6. The method of claim 5, wherein the encrypted data is previously renewed encrypted data, and the encryption secret is a previously renewed encryption secret.

7. The method of claim 5, wherein the renewed encrypted data of an outer layer contains the or each encryption secret required to access the encrypted data of an immediately preceding inner encryption layer.

8. A method for long-term storage of data, comprising the steps of:
encrypting an original user data using one or more encryption secrets, to form an encrypted data of a first, innermost encryption layer;
attaching the one or more encryption secrets to the encrypted data of the innermost layer, and encrypting the encrypted data and the one or more encryption secrets of the innermost layer to form an encrypted data of a second layer, using one or more encryption secrets of the second layer; and
forming third and subsequent layers by encrypting an encryption data and one or more encryption secrets of each immediately preceding layer.

9. The method of claim 8, wherein each encryption layer comprises validity information for validating the encoded data in that layer.

10. The method of claim 9, comprising providing context information including a time stamp when forming each encryption layer.

11. The method of claim 9, comprising forming context information including a digital signature in each encryption layer.

12. The method of claim 8, comprising, as each layer is formed, passing the one or more encryption secrets of that layer to an authorised holder.

13. The method of claim 12, comprising receiving the one or more encryption secrets of a current outermost layer from the authorised holder, forming a new outermost layer that includes the one or more encryption secrets of the current outermost layer, and returning the one or more encryption secrets of the new outermost layer to the authorised holder.

14. A method of retrieving data from a long-term storage, comprising the steps of:
retrieving an encoded data comprising a plurality of encryption layers including an outermost layer and one or more inner layers, each inner layer comprising an encrypted data and one or more encryption secrets;
receiving one or more outermost encryption secrets from an authorised holder;
decrypting the outermost layer of the plurality of encryption layers, using the one or more outermost encryption secrets, such that the encrypted data and one or more encryption secrets of an immediately preceding layer of the plurality of layers is revealed;
repeating said decrypting step, until an innermost layer is obtained; and
decrypting the encrypted data of the innermost layer to reveal an original data.

15. The method of claim 14, wherein the or each layer comprises context information, and the method comprises the step of validating the encrypted data of each layer using the context information.

16. The method of claim 15, wherein the context information includes a time stamp and a digital signature.

17. An apparatus for renewal of encrypted data, comprising:
a storage unit adapted to store encrypted data;
a renewal module adapted to receive the encrypted data from the storage unit, and to receive an encryption secret required to open the encrypted data, to attach the encryption secret to the encrypted data to form an encryption layer, and to encrypt the encryption layer to form a renewed encrypted data and a renewed encryption secret.

18. The apparatus of claim 17, wherein the renewal module is arranged to store the renewed encrypted data in the storage unit.

19. The apparatus of claim 18, wherein the renewal module is adapted such that the renewed encrypted data replaces the original encrypted data.

20. The apparatus of claim 17, wherein the renewal module is arranged to form context information attached to the encrypted data to form the encryption layer, and/or is arranged to form context information associated with the renewed encrypted data.

21. The apparatus of claim 20, further comprising a time stamper arranged to provide as said context information a time stamp associated with the renewed encrypted data, giving the time of encryption of the renewed encrypted data.

22. The apparatus of claim 20, further comprising a trusted signer arranged to provide as said context information a digital signature to the renewed encrypted data.

23. The apparatus of claim 17, wherein the renewal module is arranged to receive the original encryption secret from an authorised holder, and is arranged to pass the renewed encryption secret to the authorised holder to supersede the original encryption secret.

24. An apparatus for long-term storage of encrypted data, comprising:
a storage unit for storing a current encrypted data;
a renewal module for attaching the current encrypted data to one or more encryption secrets required to access the current encrypted data, to form an encryption layer; and
an encryption unit for encrypting the encryption layer to form a renewed encryption data, using one or more renewed encryption secrets.

25. The apparatus of claim 24, wherein the encryption unit is arranged to store the renewed encrypted data in the storage unit, to replace the current encrypted data.

26. The apparatus of claim 24, wherein the renewal module is arranged to receive one or more current encryption secrets from an authorised holder when forming the encryption layer, and is arranged to pass the one or more renewed encryption secrets to the authorised holder.

27. The apparatus of claim 24, comprising a context unit arranged to form context information associated with the renewed encrypted data.

28. The apparatus of claim 27, wherein the context unit forms validity information for validating the renewed encrypted data.

29. The apparatus of claim 28, wherein the context unit comprises a digital signer and a time stamper.

30. The apparatus of claims 24, wherein the apparatus is adapted to decrypt the current encrypted data using the one or more renewed encryption secrets, thereby revealing the encrypted data and the one or more encryption secrets of an immediately preceding layer, and to repeatedly decrypt the encrypted data of each layer using the one or more encryption secrets of that layer until an original data is revealed.

31. The apparatus of claim 30, wherein the apparatus is arranged to validate the encrypted data of each layer using context information for that layer.

32. A system for long-term storage of data, comprising:
a user apparatus for supplying an original user data and for holding one or more encryption secrets;
a storage unit for storing the original user data as an encrypted data; and
a storage controller for renewing the encrypted data, the storage controller comprising:
a renewal unit for attaching the encrypted data from the storage unit to the one or more encryption secrets from the user apparatus to form an inner encryption layer; and
an encryption unit for encrypting the inner encryption layer to form a renewed encryption data for storing by the storage unit, and one or more renewed encryption secrets for holding by the user apparatus.
